(19) United States
(12) Patent Application Publication
(10) Pub. No.: US 2002/0001193 A1
(43) Pub. Date: Jan. 3, 2002

(54) LED illumination system and manufacturing method thereof

(76) Inventors: Masami Osawa, Saitama-ken (JP); Tuneo Baba, Saitama-ken (JP); Masayuki Shimizu, Saitama-ken (JP)

Correspondence Address: William C. Rowland, BURNS, DOANE, SWECKER & MATHIS, L.L.P., P.O. Box 1404, Alexandria, VA, 22313-1404, US

(21) Appl. No.: 09/883,245

(22) Filed: Jun. 19, 2001

(30) Foreign Application Priority Data
Jun. 21, 2000 (JP) 2000-185559
Apr. 24, 2001 (JP) 2001-125386

(51) Int. Cl. F21V 21/00

(52) U.S. Cl. 362/249; 362/252; 362/800; 362/235

(57) ABSTRACT

A miniaturized LED illumination system comprising a flexible printed circuit board held in a prescribed three-dimensional shape, and a large number of light emitting diode elements mounted in accordance with a prescribed pattern directly on said flexible printed circuit board. Preferably, the system further includes a housing for holding said flexible printed circuit board in said prescribed three-dimensional shape, and a protection layer for generally protecting said light emitting diode elements.

### BACKGROUND OF THE INVENTION

1. Field of the invention

The present invention relates to a LED illumination system and a manufacturing method thereof, and more particularly, to a LED illumination system favorable, for example, to manufacturing equipments for semiconductor devices.

2. Description of related art

For example, in an illumination system for use in manufacturing equipments for semiconductor devices, the installation space of the system is often restricted. Moreover, in case of carrying out a high-grade image processing, a high-degree specification is often required to such an illumination system in terms of optical performance such as spatial distribution performance of luminous intensity.

In this kind of conventional illumination systems respectively shown in FIGS. 1 and 2, a large number of LED (light emitting diode) elements 41 each having a resin lens are regularly mounted on a non-flexible glass-base epoxy resin board 42 (see FIG. 1), or on a holder 43 (see FIG. 2) made of aluminum, resin or the like. The board 42 or holder 43 is held by a housing 44. The systems can be provided on the light emission side of the LED elements 41 with a lens, filter or diffuser 45 (see FIG. 1).

Each LED element 41 with a resin-molded lens is, however, relatively large in its size normally having a diameter of about 3 to 5 mm and a length of about 4 to 10 mm, and consequently which prevents the conventional illumination systems from sufficient miniaturization. Furthermore, in each LED element 41 with a resin lens, the size of a resulting light source is relatively large as the resin lens adjusts the directing angle of light. It is, therefore, difficult to control the optical property in the conventional illumination systems, and consequently which results in substantial non-uniformity of the illuminance distribution on the irradiated plane.

In the system where the LED elements 41 each having a resin lens are mounted on the non-flexible glass-base epoxy resin board 42, it is difficult to give a three-dimensional shape to the board 42 after the elements 41 are mounted thereon, and consequently which lowers the degree of freedom with respect to shape design of the illumination section. On the other hand, in the system where the LED elements 41 each having a resin lens are mounted on the holder 43, a relatively large degree of freedom can be ensured with respect to shape and location of the holder 43. It is, however, still difficult to give a three-dimensional shape to the holder 43 after the elements 41 are mounted thereon, and consequently which lowers the degree of freedom with respect to shape design of the illumination section.

Incidentally, there is known a technology in which a large number of LED modules are mounted on a non-flexible board, each LED module being formed by protecting a LED element with resin without providing the element with a resin lens. Similarly, in this conventional technology, it is difficult to give a three-dimensional shape to the non-flexible board after the modules are mounted thereon, and consequently which lowers the degree of freedom with respect to shape design of the illumination section.

### OBJECTS AND SUMMARY

It is, therefore, an object of the present invention to provide a miniaturized LED illumination system and a manufacturing method thereof, in which it is easy to control the optical property of illumination, and which has a large degree of freedom with respect to shape design of the illumination section.

The above and other objects of the present invention can be achieved by a LED illumination system comprising a flexible printed circuit board held in a prescribed three-dimensional shape, and a large number of light emitting diode elements mounted in accordance with a prescribed pattern directly on said flexible printed circuit board.

Specifically, said system further includes a housing for holding said flexible printed circuit board in said prescribed three-dimensional shape. Further, said system further includes a protection layer for generally protecting said light emitting diode elements. Still further, said system is provided in front of said light emitting diode elements with a lens, filter or diffuser for controlling the optical property including the spatial distribution property of luminous intensity. Furthermore, said light emitting diode elements are mounted on said flexible printed circuit board by use of conductive adhesive agent.

According to another aspect of the present invention, there is provided a method of manufacturing an illumination system, comprising the steps of mounting a large number of light emitting diode elements in accordance with a prescribed pattern directly on a flexible printed circuit board having a prescribed planar shape, forming a protection layer for generally protecting said light emitting diode elements mounted on said flexible printed circuit board, and then holding said flexible printed circuit board in a desired three-dimensional shape.

Specifically, the method further includes a step of mounting said light emitting diode elements on said flexible printed circuit board by use of conductive adhesive agent.

According to the present invention, as above mentioned, a large number of light emitting diode elements are mounted in accordance with a prescribed pattern on a flexible printed circuit board. It is, therefore, easy to give a desired three-dimensional shape to the flexible printed circuit board after the light emitting diode elements are mounted thereon, and consequently which makes it possible to ensure a large degree of freedom with respect to shape design of the illumination section.

Further, according to the present invention, a large number of light emitting diode elements themselves are mounted directly on a flexible printed circuit board without providing each element with a resin lens. It is, therefore, easy to adjust a space between small light sources, and consequently which makes it possible to easily control the optical property of illumination. Thus, according to the present invention, there is provided a miniaturized illumination system, in which it is easy to control the optical property of illumination, and which has a large degree of freedom with respect to shape design of the illumination section.

The above and other objects, features and advantages of the present invention will become apparent from the following detailed description of preferred embodiments of the present invention with reference to the accompanying drawings.

### BRIEF DESCRIPTION OF THE DRAWINGS

FIGS. 1(a) and 1(b) are schematic views showing the construction of a conventional LED illumination system;

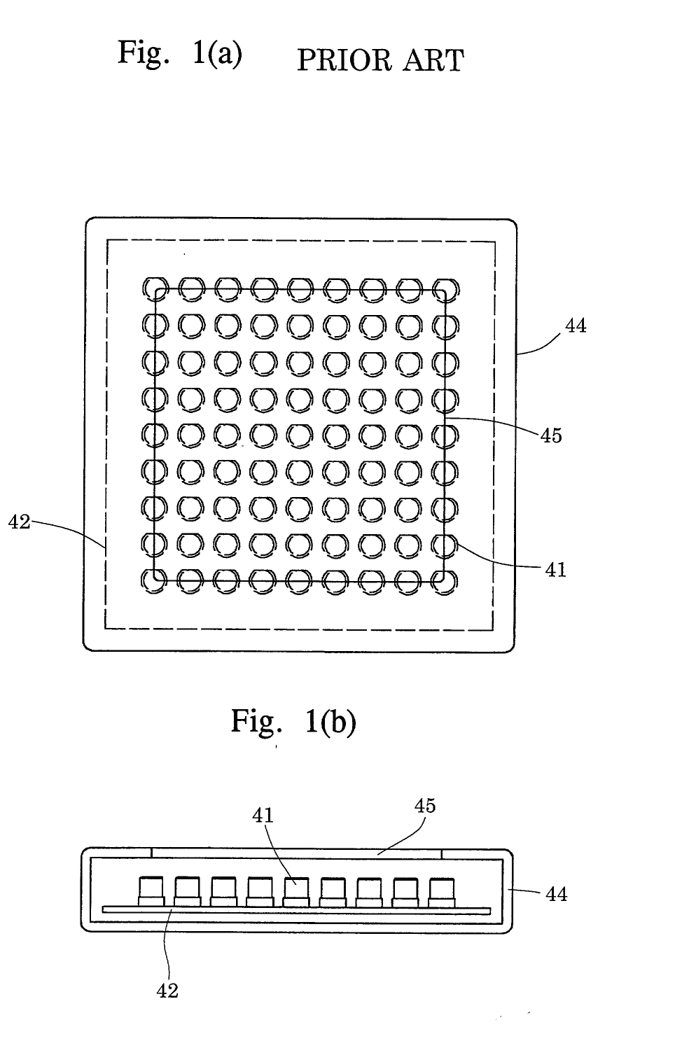

FIGS. 2(a) and 2(b) are schematic views showing the construction of another conventional LED illumination system;

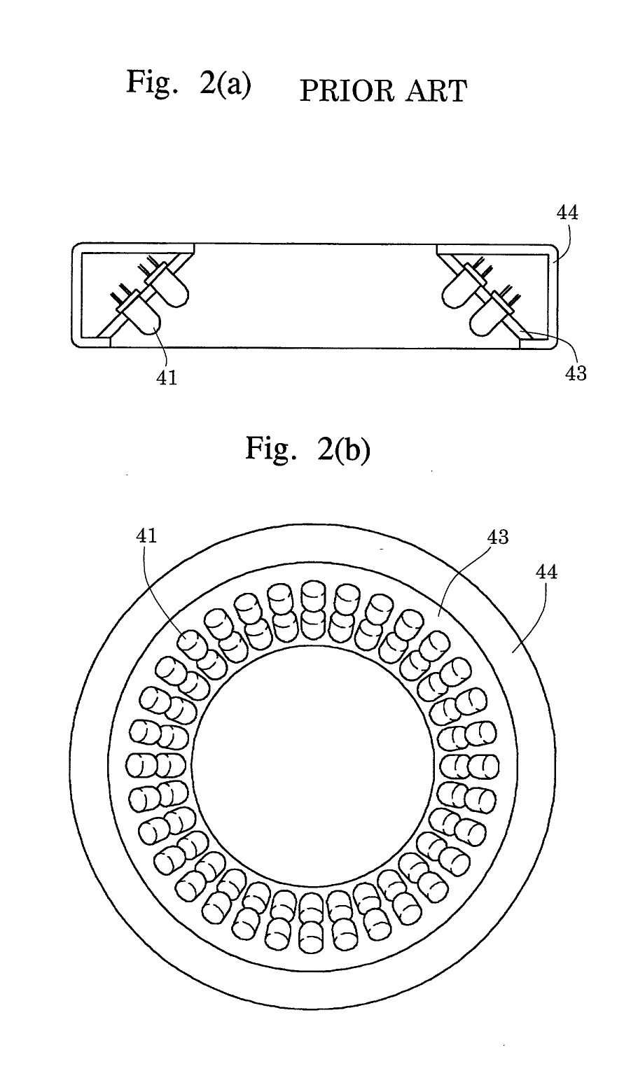

FIGS. 3(a) and 3(b) are schematic views showing the construction of a first embodiment of the LED illumination system in accordance with the present invention;

FIG. 4 is an enlarged detail view of the part A encircled in FIG. 3; and

FIGS. 5(a) and 5(b) are schematic views showing the construction of a second embodiment of the LED illumination system in accordance with the present invention.

### DESCRIPTION OF THE PREFERRED EMBODIMENTS

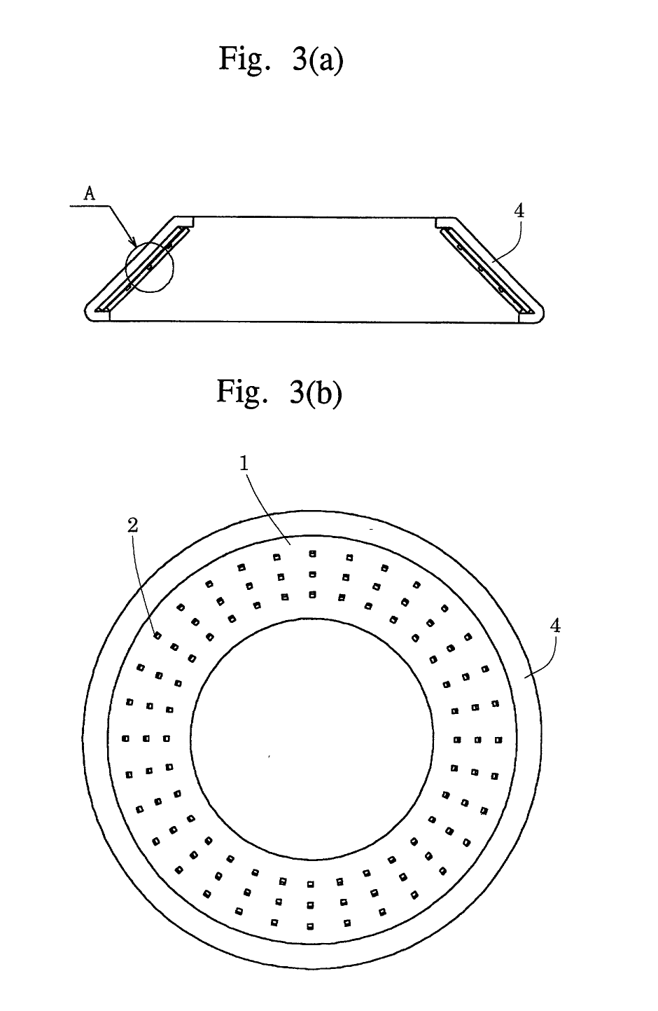

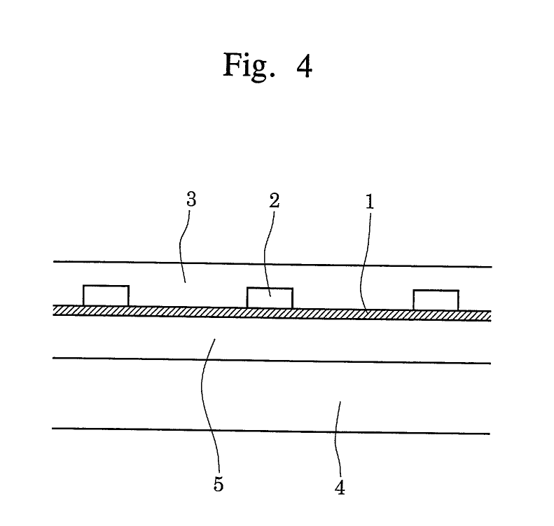

Referring to FIGS. 3 and 4, there is shown a LED illumination system in accordance with the first embodiment of the present invention. The LED illumination system includes a flexible printed circuit board 1, which is provided with a large number of light emitting diode elements 2. The light emitting diode elements are mounted in accordance with a prescribed pattern directly on the flexible printed circuit board 1.

In one embodiment, the LED illumination system includes five or more light emitting diode elements. In another embodiment, the LED illumination system includes ten or more light emitting diode elements. In yet another embodiment, the LED illumination system includes at least one hundred light emitting diode elements. Furthermore, although the preferred embodiment of the present invention is disclosed as using light emitting diodes, the present invention may use other light emitting elements, in addition to or in place of the light emitting diodes.

More specifically, each of the light emitting diode elements 2 is respectively attached to the flexible printed circuit board 1 by use of, for example, conductive adhesive agent. In addition, terminals of each light emitting diode element 2 are electrically connected to the corresponding terminals formed on the flexible printed circuit board 1. Furthermore, as shown in FIG. 4, the LED illumination system is provided with a protection layer 3 for generally protecting the light emitting diode elements 2 mounted on the flexible printed circuit board 1. The protection layer 3 can be formed by, for example, coating a suitable transparent resin almost over the whole surface of the flexible printed circuit board 1.

The flexible printed circuit board 1 with the light emitting diode elements 2 mounted thereon and the protection layer 3 formed thereon is held in a three-dimensional annular shape by means of a housing 4 which functions both as a holding member and a radiating member. The LED illumination system can be provided between the flexible printed circuit board 1 and the housing 4 with a radiating sheet 5.

Incidentally, the flexible printed circuit board 1 has, in its planar developed condition, a circular arc shape with a prescribed width. In the first embodiment, the light emitting diode elements 2 are mounted in accordance with a prescribed pattern directly on the developed planar flexible printed circuit board 1 with a circle arc shape. In order to form the protection layer 3 for generally protecting the light emitting diode elements 2 mounted on the flexible printed circuit board 1, a suitable transparent resin can be coated almost over the whole surface of the flexible printed circuit board 1.

Then the flexible printed circuit board 1 with the light emitting diode elements 2 mounted thereon and the resin protection layer 3 formed thereon becomes held in a three-dimensional annular shape by means of the housing 4 which has also a corresponding three-dimensional annular shape. Thus, the flexible printed circuit board 1 held by the housing 4 presents a three-dimensional annular shape obtained by cutting the side face of a circular cone with a pair of planes each parallel to the bottom face thereof. Both ends of the flexible printed circuit board 1, having a circular arc shape in its planar condition, can be fixed to each other.

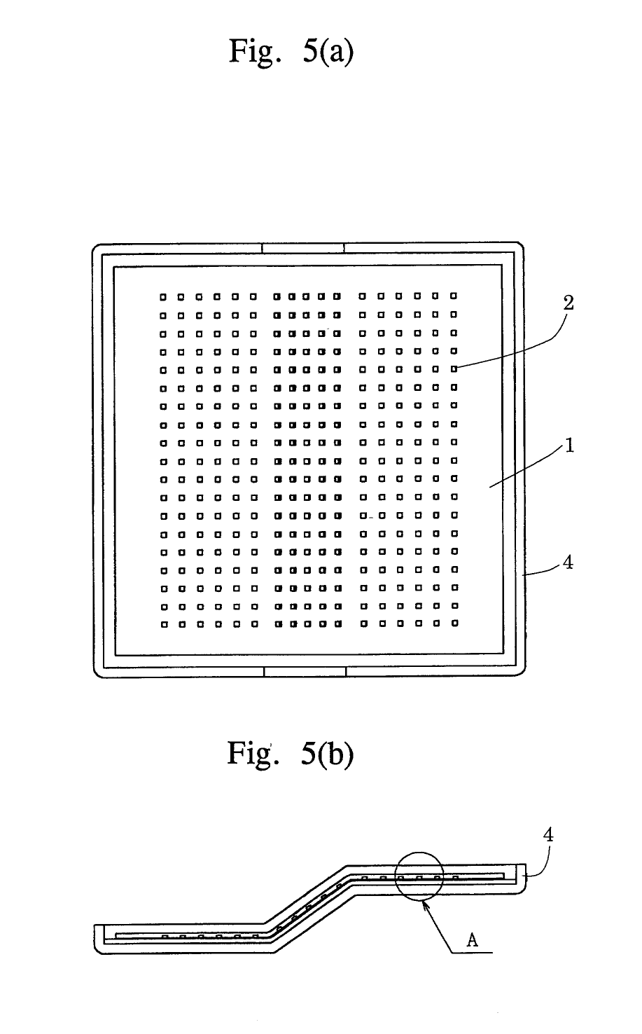

Referring to FIG. 5, there is shown a LED illumination system in accordance with the second embodiment of the present invention. The arrangement of the second embodiment is similar to that of the first embodiment. The flexible printed circuit board 1 according to the second embodiment, however, presents a three-dimensional rectangular shape as shown in FIG. 5, while it presents a three-dimensional annular shape in the first embodiment.

Thus, in the first and second embodiments, the light emitting diode elements 2 are mounted in accordance with a prescribed pattern on the flexible printed circuit board 1. It is, therefore, easy to give a desired three-dimensional shape to the flexible printed circuit board 1 after the light emitting diode elements 2 are mounted thereon, and consequently which makes it possible to ensure a large degree of freedom with respect to the shape design of the illumination section.

Moreover, in the first and second embodiments, the small light emitting diode elements 2 themselves are mounted directly on the flexible printed circuit board 1 without providing each light emitting diode element with a resin lens. It is, therefore, easy to adjust a space between small light sources, and consequently which makes it possible to control the optical property of illumination such as the spatial distribution property of luminous intensity. In addition, it becomes possible to further control the optical property (spatial distribution property of luminous intensity) by providing in front of the light emitting diode elements 2 with, for example, a lens, filter or diffuser.

Although the above embodiments show the examples in which the flexible printed circuit board 1 is held in a three-dimensional annular or rectangular shape, it is possible within the scope of the present invention to form the illumination section held in various shapes as desired.

In the above embodiments, since each light emitting diode element 2 is a semiconductor device itself, it is impossible to use a solder joint for the purpose of mounting each light emitting diode element 2 on the flexible printed circuit board 1. This is because the soldering material does not fit, from the viewpoint of wetting, to a light emitting diode element 2, and because a light emitting diode element 2 is so small (for example about 0.3 mm by 0.3 mm) that it is almost impossible to carry out a soldering operation. In the above embodiments, therefore, a large number of light emitting diode elements 2 are mounted on the flexible printed circuit board 1 by use of, for example, conductive adhesive agent.

More specifically, silver paste (silicone type) as conductive adhesive agent can be spread in a large number of spots on the flexible printed circuit board 1, the light emitting diode elements 2 are then placed thereon. Carrying out a suitable heating treatment melts silver paste to attach the light emitting diode elements 2 to the flexible printed circuit board 1. Conductive adhesive agent usable in the present invention is not limited to silver paste, but other conductive adhesive agents such as copper or gold paste can be used depending upon the conditions.

Although it is possible to manually carry out the step of mounting the light emitting diode elements 2 to the flexible printed circuit board 1, it is advantageous to utilize the surface mounting technology in the field of semiconductor devices. In this case, a dispenser carries out a step of spreading silver paste, and a mounting machine carries out a step of placing in position each light emitting diode element 2 held by absorption. Furthermore, a bonding machine carries out a step of bonding a gold line between the board 1 and each element 2, and finally a step of heating silver paste is carried out by means of a prescribed heater.

As above described, it is possible in accordance with the present invention to provide a miniaturized illumination system, in which it is easy to control the optical property of illumination, and which has a large degree of freedom with respect to shape design of the illumination section. The LED illumination system of the present invention is not limited to one for use in manufacturing equipments for semiconductor devices, but can be applied to illumination for manufacturing equipments and inspection equipments for general products including semiconductor devices.

Although the invention thus has been shown and described with reference to specific embodiments, it should be noted that the present invention is in no way limited to the details of the illustrated structures but changes and modifications may be made within the scope of the appended claims.

1. An LED illumination system comprising:
a flexible printed circuit board held in a prescribed three-dimensional shape, and
a plurality of light emitting diode elements mounted in accordance with a prescribed pattern directly on said flexible printed circuit board.

2. The LED illumination system as set forth in claim 1, which further includes a housing for holding said flexible printed circuit board in said prescribed three-dimensional shape.

3. The LED illumination system as set forth in claim 2, which further includes a protection layer for generally protecting said light emitting diode elements.

4. The LED illumination system as set forth in claim 3, further comprising a lens, filter or diffuser for controlling an optical property including the spatial distribution property of luminous intensity.

5. The LED illumination system as set forth in claim 4, wherein said light emitting diode elements are mounted on said flexible printed circuit board by use of conductive adhesive agent.

6. The LED illumination system as set forth in claim 1, wherein the plurality of light emitting diode elements includes a large number of light emitting diode elements.

7. A method of manufacturing an illumination system, comprising the steps of:
mounting a plurality of light emitting diode elements in accordance with a prescribed pattern directly on a flexible printed circuit board having a prescribed planar shape,
forming a protection layer for generally protecting said light emitting diode elements mounted on said flexible printed circuit board, and
then holding said flexible printed circuit board in a desired three-dimensional shape.

8. The method as set forth in claim 7, which further includes a step of mounting said light emitting diode elements on said flexible printed circuit board by use of conductive adhesive agent.

9. The method as set forth in claim 7, wherein the plurality of light emitting diode includes a large number of light emitting diode elements.
